(19) United States
(12) Patent Application Publication
(10) Pub. No.: US 2002/0038572 A1
(43) Pub. Date: Apr. 4, 2002

(54) Fluid level indicating device for any container

(76) Inventor: Arthur G. Drinkwater, Key West, FL (US)

Correspondence Address: Richard C. Litman, LITMAN LAW OFFICES, LTD., P. O. Box 15035, Arlington, VA, 22215, US

(21) Appl. No.: 09/953,150

(22) Filed: Sep. 17, 2001

Related U.S. Application Data
(63) Continuation-in-part of application No. 09/679,048, filed on Oct. 4, 2000.

(51) Int. Cl. G01F 23/02

(52) U.S. Cl. 73/323

(57) ABSTRACT

A fluid-level indicating device comprises a tube having an upper section provided with a visible, movable structure which indicates when a container is filled with liquid. In a first embodiment, the indicator is a solid bead positioned above a venturi section formed in the tube. In a second embodiment, the indicator takes the form of an indicator fluid forming a plug or seal disposed in a continuous loop section formed in the tube.

This Application is a continuation-in-part of Application Serial No. 09/679,048, filed Oct. 10, 2000.

### BACKGROUND OF THE INVENTION

1. Field Of The Invention

The present invention generally relates to fluid-level gauges. More specifically, the present invention is drawn to an apparatus which indicates when a fluid container has been filled.

2. Description Of Related Art

Dispensing fluid into a container presents a problem when there are no gauges to indicate when the container is full. This problem occurs often when boaters attempt to fill the fuel tank of a boat. Consequently, the fuel tank is often overfilled, causing gasoline to overflow from the filler pipe and onto the gunnel or deck. The spilled gasoline damages the finished area around the filler pipe and creates a fire hazard. Overfilling may also contribute to environmental pollution, in that some of the gasoline may spew out of the tank vent and into the water. Further, the loss of costly gasoline makes the joy of boating more expensive than it need be.

An inexpensive, portable, uncomplicated device which could indicate when the gasoline tank or any fluid container is full and which could easily be adapted for use in almost any container-filling situation, would certainly be welcomed in the art.

The prior art is replete with a variety of apparatus for determining the level of fluids in a container. For example U.S. Pat. Nos. 2,086,645 (Staber) and 2,376,459 (Stevens) show measuring gauges incorporated as part of the fluid holding tank.

U.S. Pat. Nos. 3,990,307 (Guidcelli), 5,507,326 (Cadman et al.), 5,717,383 (Dreyer et al.), European Patent number 0,338,400 , and British Patent number 2,261,952 A employ relatively complicated electrical systems to determine the level of fluid in a tank.

U.S. Pat. No. 4,198,848 (Mealey) utilizes a bubble system and scale indicator for aligning comparative levels on a bubble pipe with the level of fluid in a tank.

U.S. Pat. No. 4,343,184 (Jaulmes) discloses a spring biased membrane used to determine fluid level.

U.S. Pat. No. 4,375,765 (From) discloses a level indicating device comprising a flexible container and a transparent, flexible tube wherein an equilibrium condition indicates the level of the fluid.

U.S. Pat. No. 5,279,252 (Martelly) employs a back-flow preventor and an indicator installed in the surface of a boat for determining the level of fuel in a fuel tank.

U.S. Pat. No. 5,898,376 (Webb) discloses an alarm system permanently fixed to a fuel tank vent pipe. The alarm is actuated when overflow fluid enters the vent pipe.

None of the above inventions and patents, taken either singularly or in combination, is seen to disclose an easy-to-use fluid level indicating device as will subsequently be described and claimed in the instant invention.

### SUMMARY OF THE INVENTION

In a first embodiment, the instant invention comprises a tube having a transparent venturi section formed in an upper portion thereof. A small, light-weight bead is disposed in the tube immediately above the venturi section.

When utilized, the tube is inserted into a container to be filled so that the lower end of the tube is adjacent the top or full-level of the container. When the container is filled with fluid, and the fluid commences to rise into the tube, air in the tube will be compressed and displaced upward through the tube. The compression and displacement upward will be such that air accelerating through the venturi section will cause the bead to move. This movement will indicate to the person dispensing the fluid that the fluid has reached the desired level, or that the container is full. Thus, the dispensing operation is halted preventing fluid from overflowing from the container.

The tube may be coupled to a funnel, which funnel is provided with a viewing area. The venturi section of the tube is positioned adjacent the funnel's viewing area so that bead movement may be easily seen by the user.

In a second embodiment, a tube is formed with a continuous transparent looped section adjacent the tube's upper end. A small amount of a suitable indicator fluid (one or two drops) is inserted in the tube. The indicator fluid will settle in the bottom portion of the loop forming a seal within the tube. The tube is inserted in a container to be filled such that the lower end of the tube exits at the desired level, or full-line of the container. Dispensed fluid reaching the top of the container and entering the bottom of the tube will function to compress air in the tube, causing the air to move upwardly in the tube and displace the indicator fluid upwardly. Movement of the indicator fluid in the loop will indicate that the dispensed fluid has reached the desired level or that the container is full.

Accordingly, it is a principal object of the invention to provide a device for indicating the level of fluid within a container.

It is another object of the invention to provide a device for indicating the level of fluid within a container or when a container is filled, which device may be portable or permanently installed.

It is a further object of the invention to provide a device for indicating the level of fluid in a container or when a fluid container is filled, which device is adapted for use with a specially designed funnel.

Still another object of the invention is to provide a device for indicating the level of fluid in a container or when a fluid container is filled, which device is easy to use.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental view of a fluid level indicating device according to a first embodiment of the present invention.

FIG. 2 is a perspective, cut-away view of a fluid level indicating device according to a first embodiment of the present invention.

FIG. 3 is an environmental view of a second embodiment of a fluid level indicating device according to the present invention.

FIG. 4 is a partial view of a second embodiment of a fluid level indicating device according to the present invention.

Similar reference characters denote corresponding features consistently throughout the attached drawings.

### DETAILED DESCRIPTION OF THE PREFERRED EMBODIMENTS

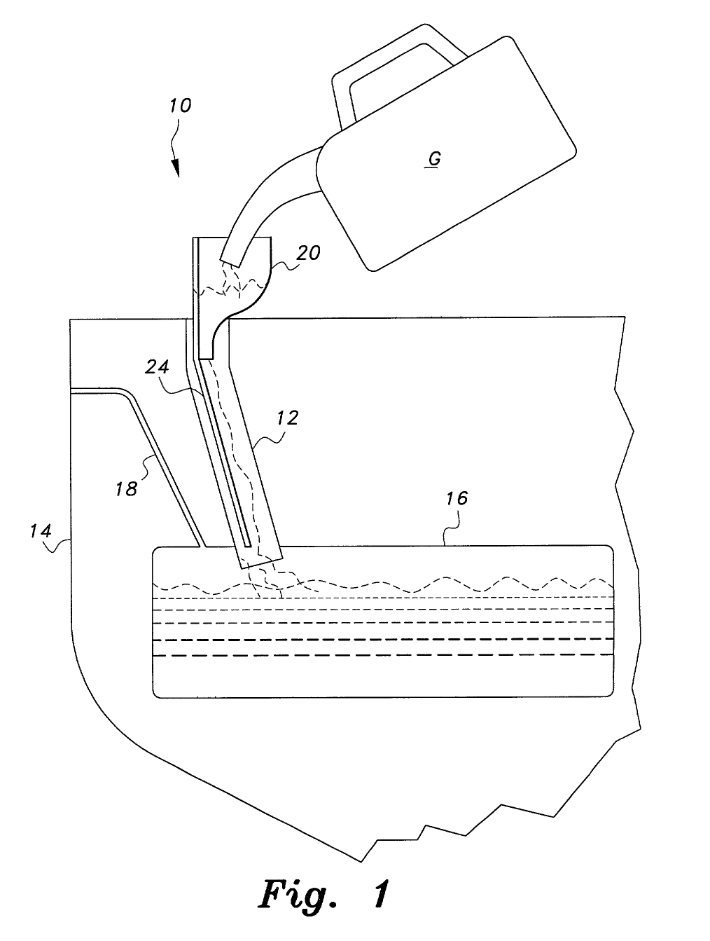

As illustrated in FIG. 1 the present invention is indicated generally at 10. The invention as shown is inserted in the filler tube 12 of a boat 14. Filler tube 12 extends into gasoline tank 16. A pipe 18 vents tank 16 to the atmosphere. Boat 14, tube 12, tank 16 and vent 18 are conventional and are not part of the instant invention per se. A dispenser G is provided for filling tank 16 with gasoline poured through a funnel 20.

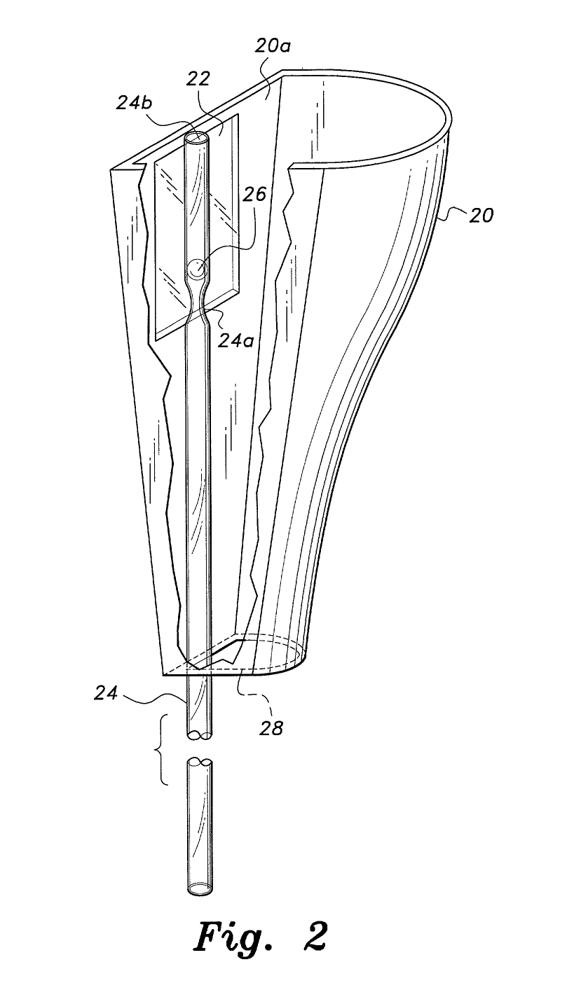

As best seen in FIG. 2 funnel 20 has a wall 20a fashioned with an opening therein. The opening is covered with a transparent plastic or unbreakable glass material 22 such that a viewing area is formed adjacent the upper end of the funnel. The funnel may be fabricated from any suitable material (plastic, metal, etc.). A tube 24 provided with a venturi section 24a is disposed within funnel 20 such that the venturi section can be viewed through transparent material 22. In the preferred embodiment tube 24 is fabricated of any suitable material (plastic, glass, etc.). However, the tube may be fabricated from a metallic or composite material if the venturi section is transparent. Tube 24 may be attached to funnel 20 by any convenient means. A light-weight bead 26 is disposed in tube 24 immediately above venturi section 24a. Bead 26 is fabricated of material which is impervious to various fluids such as gasoline and has a diameter slightly smaller than that of tube 24 so that the bead is allowed to move freely in tube 24. End 24b of tube 24 is partially closed to prevent the bead from falling out. Tube 24 is designed to extend through the lower end of funnel 20 to a point in the filler tube approximately at the top of the boat's fuel tank (see FIG. 1). The funnel is provided with a fuel filter 28.

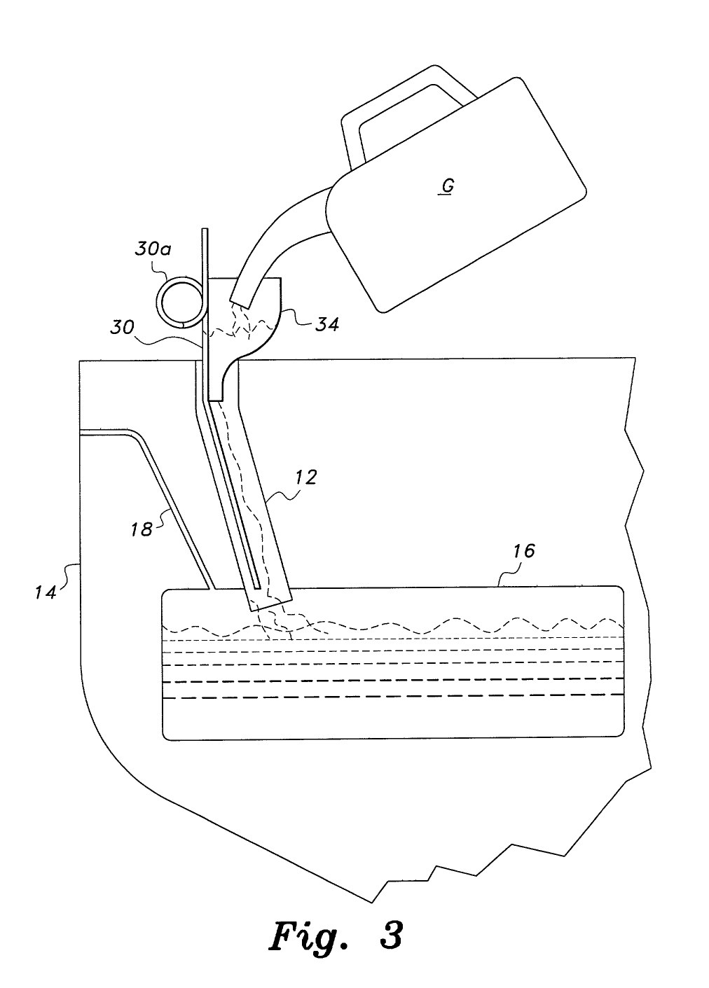

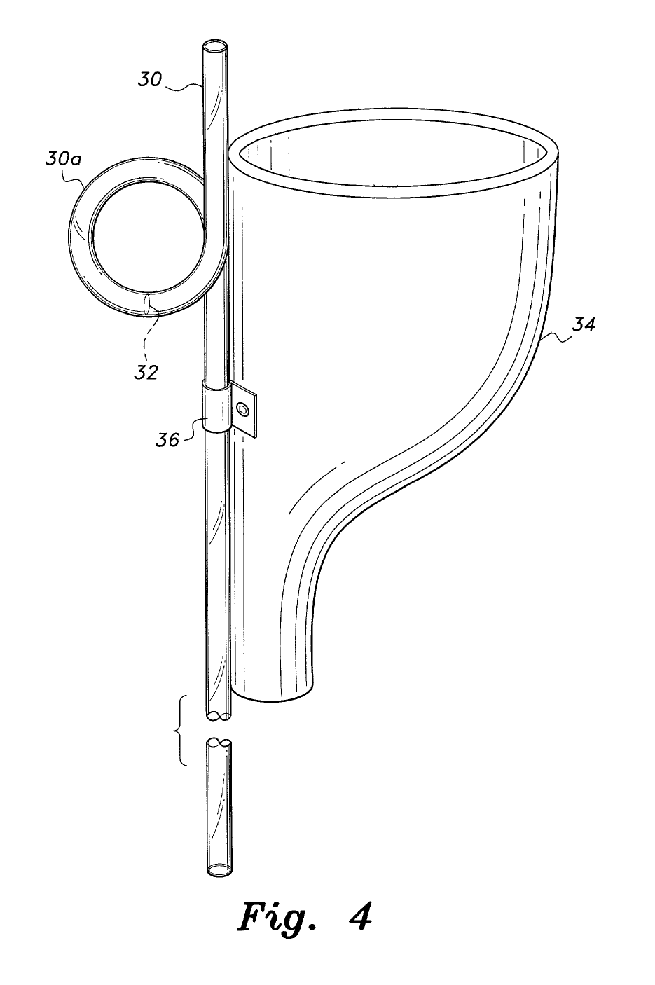

As illustrated in a second embodiment of the invention (FIGS. 3 and 4), a tube 30 is provided adjacent its upper end with a continuous transparent looped section 30a . A small amount of any suitable indicator fluid 32 is disposed in tube 30. Under normal equilibrium conditions, indicator fluid 32 will settle in the lower portion of looped section 30a. Although not required, a funnel 34 may be utilized to support tube 30 when filling a container 16. Tube 30 may be adjustably disposed on and removed from the funnel. As shown, a conventional clip 36 is used to accomplish these functions. It is recognized that other means (hook and loop fasteners, for example) may be used in lieu of a clip. It is also recognized that the tube could be permanently molded to the funnel if desired.

In use, as discussed above, when dispensed fluid reaches a desired level or container 16 is full, the dispensed fluid in the container will be forced to flow upwardly into tube 30 and exert pressure on air in the tube 30. The flow of compressed air in the tube will cause indicator fluid 32 to move upwardly in the loop and flatten on the wall of the loop to allow the air to pass. Upon observing movement of the fluid in the loop, a user will know that the dispensed fluid has reached a desired level or that the container is full. When the filling operation is stopped, indicator fluid 32 will again settle in the lower part of the looped section.

The indicator fluid may be oil, silicone, or other fluids which are relatively impervious to changes in the temperature of the ambient air.

It is to be understood that the present invention is not limited to the embodiments described above, but encompasses any and all embodiments within the scope of the following claims.

I claim:

1. A fluid level indicating device adapted for insertion into a fluid container to be filled, said device comprising:
an elongate tube, said tube having an open upper end and an open lower end and having a continuous loop formed therein adjacent the upper end; and
a plug formed from indicator fluid disposed in said continuous loop.

2. A fluid level indicating device as recited in claim 1, wherein said tube is fabricated from a plastic material.

3. A fluid level indicating device as recited in claim 1, wherein said tube is fabricated from a glass material.

4. A fluid level indicating device as recited in claim 1, wherein said indicator fluid is oil.

5. A fluid level indicating device as recited in claim 1, wherein said indicator fluid is silicone.

6. A fluid level indicating device as recited in claim 1, wherein said tube is transparent.

7. A fluid level indicating device as recited in claim 1, wherein the loop defined in said tube is transparent.

8. A fluid level indicating device adapted for insertion into a fluid container to be filled, said device comprising:
an elongate tube, said tube having an open upper end and an open lower end and having a continuous loop formed therein adjacent the upper end;
a plug formed from indicator fluid disposed in said continuous loop;
a funnel; and
means for attaching said elongate tube to said funnel.

9. A fluid level indicating device as recited in claim 8, wherein said means for attaching is a clip, whereby said elongate tube may be removably and adjustably attached to said funnel.

10. A fluid level indicating device as recited in claim 8, wherein said tube is fabricated from a plastic material.

11. A fluid level indicating device as recited in claim 8, wherein said tube is fabricated from a glass material.

12. A fluid level indicating device as recited in claim 8, wherein said tube is transparent.

13. A fluid level indicating device as recited in claim 8, wherein the loop defined in said tube is transparent.

14. A fluid level indicating device as recited in claim 8, wherein said indicator fluid is oil.
